(19) United States
(12) Patent Application Publication
(10) Pub. No.: US 2021/0182987 A1
(43) Pub. Date: Jun. 17, 2021

(54) System and Method for Vertical Integration of Real Estate Related Services

(71) Applicant: Urban Technologies Ltd

(72) Inventors: Rashid Al Ghurair, Dubai (AE); Mohammad Kaswani, Abu Dhabi (AE); Muath Barakat, Dubai (AE); Tala Nsouli, Dubai (AE); Eman Al Tal, Dubai (AE); David Rodriguez, Dubai (AE); Alaa Alnobani, Dubai (AE); Mohamad Hamade, Dubai (AE)

(21) Appl. No.: 17/121,139

(22) Filed: Dec. 14, 2020

Related U.S. Application Data
(60) Provisional application No. 62/948,130, filed on Dec. 13, 2019.

(51) Int. Cl. G06Q 50/16; G06N 20/00; G06N 5/04; G06Q 30/06

(52) U.S. Cl. CPC G06Q 50/16; G06Q 30/0645; G06N 5/04; G06N 20/00

(57) ABSTRACT

The Current invention provides a system and method for optimizing real estate renting services and solving known problems in the industry.

### CROSS-REFERENCE TO RELATED APPLICATION

This application claims the benefit of U.S. Provisional Application No. 62/948,130, filed Dec. 13, 2019, which is incorporated by reference in its entirety herein.

### TECHNICAL FIELD

This invention relates to a computer implemented invention for optimising real estate renting and more specifically to a system and method for vertical integration of real estate related services.

### BACKGROUND

The rental market has not changed in the past 100 years leaving the rental journey fragmented. Today's rental market is an Oversupplied market, Properties struggle to standout, Prices are set without reliable data, Finding the right tenants is a challenge. Rentals have not changed in the last 100 years. Better tenant experiences lead to better communities, But the rental experience has not really changed in the last 100 years. Most people still use agents to facilitate finding and renting a home, following a process established in the 1900s.

False photography, inconvenient viewing times, exhausting negotiations, and inflexible payment options—we all know that finding and moving into your new home is an overwhelming experience. The journey is packed with endless moving parts, and every one of them feels completely out of your control. FIG. 1 identifies the tenants & landlords most pressing pain points in the traditional rent market.

There is a need in the field for solutions to deal with the identified deficiencies.

### SUMMARY OF THE INVENTION

One aspect of the invention relates to Urban simple visiting experience. In this experience, Urban users can enjoy a simple visit experience to any urban home with a smart lock. Each home has a specific unique ID that will be available to users on the door. This experience allows all user quick accessibility to home even if not a registered Urban user.

Once users arrive to the door location, they can access the property by utilizing any of the 4 methods.

a) Human assisted call—With Urban simple visiting experience users will be able to open any urban home door with a simple human assisted call.

b) IVR call—With Urban simple visiting experience users will be able to open any urban home door by simple IVR assisted call

c) SMS—With Urban simple visiting experience users will be able to open any urban home door with a text message. With each home having a unique ID user can send SMS to Urban number with special format. By way of a non-limiting example: Visit Home-ID, Visit 4567373.

d) QR reader—With Urban simple visiting experience users will be able to open any urban home door with a QR code scanner.

Another aspect of the invention relates to vendor agnostic smartlock management platform—For self-visitation enablement, Urban smartlock management platform (USMP) supports any lock type based on their communication protocols: UDP (NB-IoT), Bluetooth, and HTTPS/SSL (over3G/4G technologies). Any smartlock vendor supporting these communication channels and protocols can be seamlessly integrated with USMP's existing smartlock solution framework.

Moreover, USMP provides a Vendor Agnostic property visiting experience irrespective of the vendor, communication protocol, or the lock type installed at the property.

USMP also enables our operations and field teams to assign, configure, or change the lock type for a property during or even after the lock installation.

A yet another aspect of the invention relates to Smart Bluetooth connectivity—Urban has developed an advanced and smart algorithm in collaboration with Amper called UrbanSmart BT Connect that utilizes the smart-lock's vibration/motion detection technology to solve the universally-known problem of Bluetooth's heavy battery usage increases the smartlock Bluetooth advertisement frequency from 5 secs to 100 milliseconds for a minute only upon detecting a vibration (door knock) for facilitating the smooth Bluetooth connection. For rest of the time the BT advertisement frequency stays at 5 secs reducing the overall battery consumption considerably, thus optimizing the battery usage as well as the battery life.

The platform consists of below core modules:

1-Coherent Discovery

Urban offers a dynamic content discovery experience allowing users to customize home screen based on their needs, there are different variations of the explore screen is available based on location. Explore screen is also curated through the concept of carousels.

2-Comprehensive Property Details

Understanding user's needs of authentic listings Urban gives a comprehensive details of property conditions by offering different property imagery; high quality photos, real 360 walkthrough, floor plans & street view.

In addition, fully detailed description & property amenities users will have quick access to map location with building information, inspection report & landlord terms of renting.

3-On-Demand Self-LED Visitation

Being first in market Urban platform enables users to visit properties without assistance of realtor with a fully self-led-visitation feature powered by smart lock & NB-IoT technology.

4-Real-Time Rental Bidding Engine

The platform allows users (prospect tenants) to place offers on property triggering a real-time auction window. All properties on auction will be featured in special carousel in explore screen bringing more attention to these properties.

Users can update or cancel their offers within the timed window. Once the window closes all offers will be automatically evaluated to ensure best ROI for landlord.

5-Homeowners Dashboard

Urban empower homeowners by providing them with an interface to monitor & track the performance of their listed properties.

### BRIEF DESCRIPTION OF THE DRAWINGS

FIG. 1 shows most pressing pain points in the traditional rent market.

FIG. 2 shows functional architecture of the platform according to an embodiment of the invention.

FIG. 2a shows technical Architecture of the platform according to an embodiment of the invention.

FIG. 3 shows a schematic view of the On Demand self-led visitation technology.

FIG. 4 shows a schematic view of the smart lock network.

FIG. 5 shows a schematic view of the real time rental bidding engine.

FIG. 6 shows a schematic view of the fully digital long-term renting journey technology.

FIG. 7 shows a schematic view of the data warehouse architecture.

FIG. 8 shows a schematic view of the smart lock APN network.

FIG. 9 shows a schematic view of the network architecture.

FIG. 10 shows a schematic view of the CI-CD architecture.

FIG. 11 shows a schematic view of the property visiting journey.

FIG. 12 shows a flow chart describing a protocol used by the URBAN system to verify the identity of the user and allow access to the property.

FIG. 13 shows a flow chart describing another protocol used by the URBAN system to verify the identity of the user and allow access to the property.

FIG. 14 shows a flow chart describing another protocol used by the URBAN system to verify the identity of the user and allow access to the property.

FIG. 15 shows a flow chart describing another protocol used by the URBAN system to verify the identity of the user and allow access to the property.

FIG. 16 shows a flow chart describing another protocol used by the URBAN system to verify the identity of the user and allow access to the property.

FIG. 17 shows a flow chart describing the operation of the Smart BT technology.

FIG. 18 shows the graphical user interface of the URBAN platform with customizable aspects of the user interface.

FIG. 19 shows the graphical user interface of the URBAN platform when used for viewing listing of properties.

FIG. 20 shows the graphical user interface of the URBAN platform when used for self-led visitation of properties.

FIG. 21 shows the graphical user interface of the URBAN platform when used for bidding on properties.

FIG. 22 shows the graphical user interface of the URBAN platform when used for listing properties.

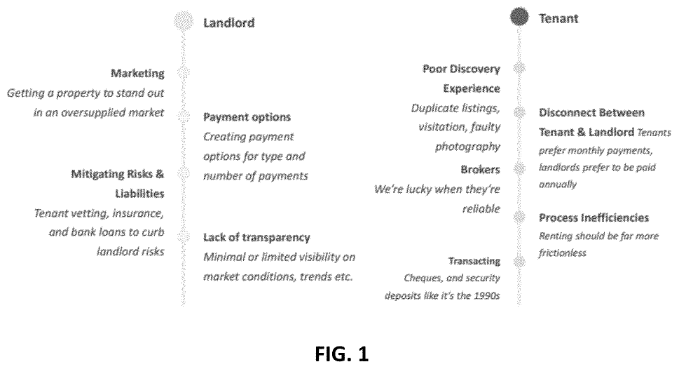

### DETAILED DESCRIPTION

Urban brings the entire rental journey online. Discover pre-inspected homes, visit without an agent and pay your rent monthly. It's reinventing the way renters discover and live in their new homes and making it easier than ever for landlords to list, rent out and manage their properties. Some of the features included under the Urban platform may described as follows:

Discover places like never before—professional photography and 3D walkthroughs

Visit—Book on demand viewings, 24/7 viewings, Digital and secure access

Transact—close the transaction digitally-in-app bidding, and flexible payment cycles.

Specifically, our technology provides:
In-house designed & developed with full Intellectual Property ownership
Smart Lock (IoT) with AI Technology enabling self-visitation experience
Machine Learning and Advanced Analytics enabling smarter recommendations including pricing
Complete end to end payment management system enabling renting and other payments to be online
360 degrees virtual tour experience
State of the art well architectured Microservices with CDN architecture

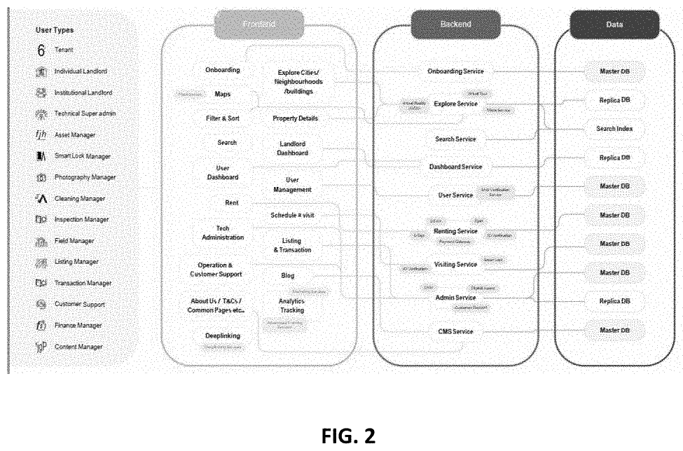

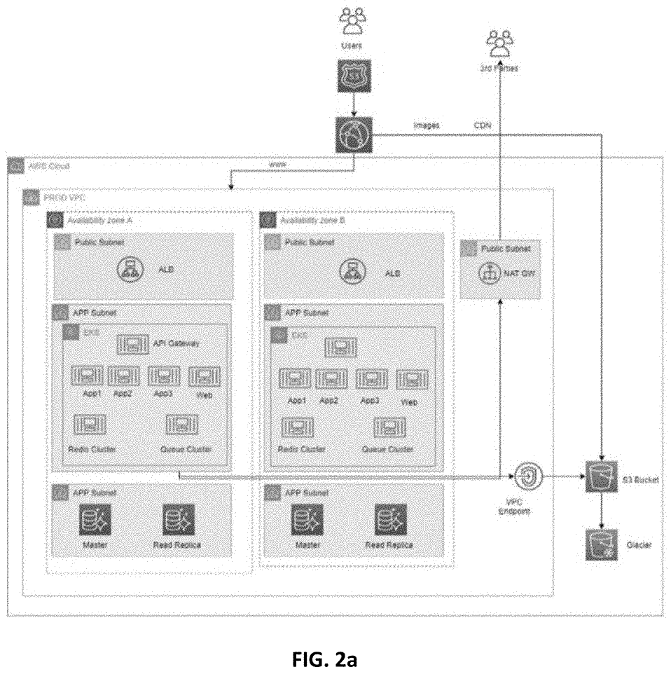

FIG. 2 shows an overview microservices system architecture from a functional point of view showing the relation between the different types of users functions and the backend services used to serve each functionality. FIG. 2a shows an overview of the infrastructure implemented to host the Urban microservices application architecture using cloud native services.

Core Functionalities

The Urban platform includes core modules:

Coherent Discovery:

Urban offers a dynamic content discovery experience allowing users to customize home screen based on their needs. There are different variations of the explore screen is available based on location. Explore screen is also curated through the concept carousels. By way of non-limiting example, customization may include:
In multilocation explore screen featuring different property and neighborhoods carousels,
a single neighborhood explore screen featuring different properties and buildings available in that location,
an expanded carousel of type properties group under “close to metro” Feature allows user to build it in a vertical format and sort by different sorting options,
an expanded view of neighborhood type carousel allowing users to view all neighborhoods in grid view sort it by different sorting options,
an expanded view of building type carousel allowing users to view all buildings in grid view and sorted by different sorting options.

Urban offers a dynamic content discovery experience allowing users to customize home screen of the graphical user interface based on their needs, there are different variations of the explore screen is available based on location. Explore screen is also curated through the concept of carousels.

Comprehensive Property Details

Understanding user's needs of authentic listings Urban gives a comprehensive details of property conditions by offering different property imagery; high quality photos, real 360 walkthrough, floor plans & street view. In addition, fully detailed description & property amenities users will have quick access to map location with building information, inspection report & landlord terms of renting.

By way of a non-limiting example, the platform will provide the user with:
a property detail screen showing Image Gallery, title, price and general property information,
a real 360 interactive walkthrough of the property offering the user full overview of property the floor plan, doll house and a walkthrough;
Google Street View of a single property order building showing user the exterior area of property location;
a comprehensive property description with full facilities lists available in building and neighborhood features;
house inspection report showing major issues in the property;
accurate pin location of property along with building information.

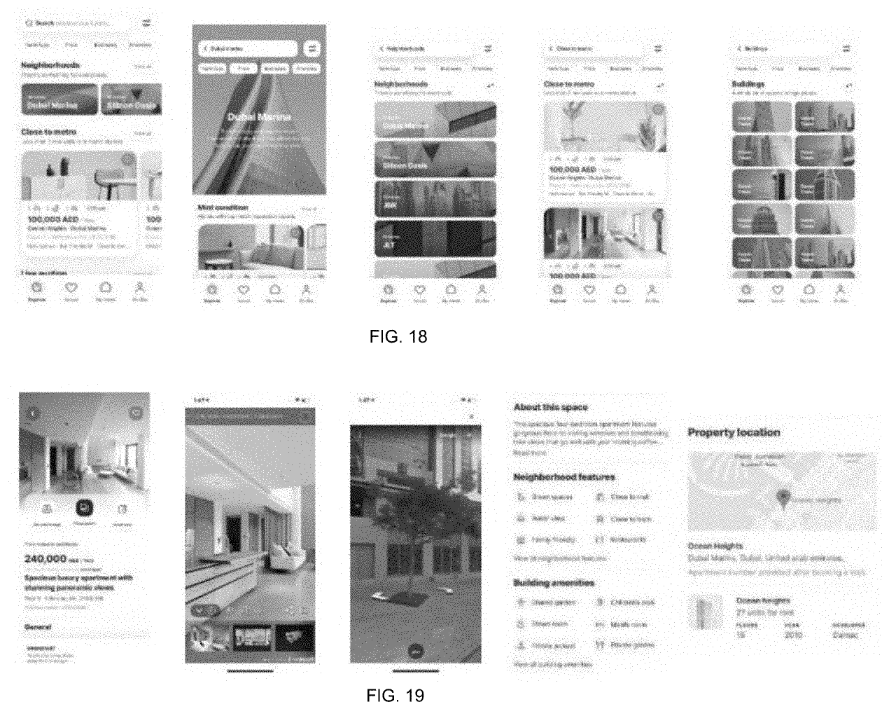

By understanding user's needs of authentic listings, Urban gives comprehensive details of property conditions by offering different property imagery; high quality photos, real 360 walkthrough, floor plans & street view. In addition to fully detailed description & property amenities, users will have quick access to map location with building information, inspection report & landlord terms of renting. FIG. 18 shows the graphical user interface of the URBAN platform when used for viewing listing of properties

On Demand Self-LED Visitation

Being first in the market, Urban platform enables users to visit properties without assistance of realtor with a fully self-led visitation feature powered by smart lock & NB-IoT technology.

By way of a non-limiting example, the Urban platform provides the following services to the user:
Booking the visit, which includes: Calendar booking configured on individual property level, the time slots and days availability;
viewing confirmation with location and Accessibility information required for visiting;
viewing and managing scheduled an historical visits;
dual interface switched at the time of viewing enabling the user to acknowledge their arrival

During the visit, the following features and services are available:
property door with lock installed and entering instruction;
additional user verification through one-time password send to user registered phone number;
screen informing user to interact with the lock waking up the lock to initiate communication with back end system;
final screen after opening success with instruction of exiting property.

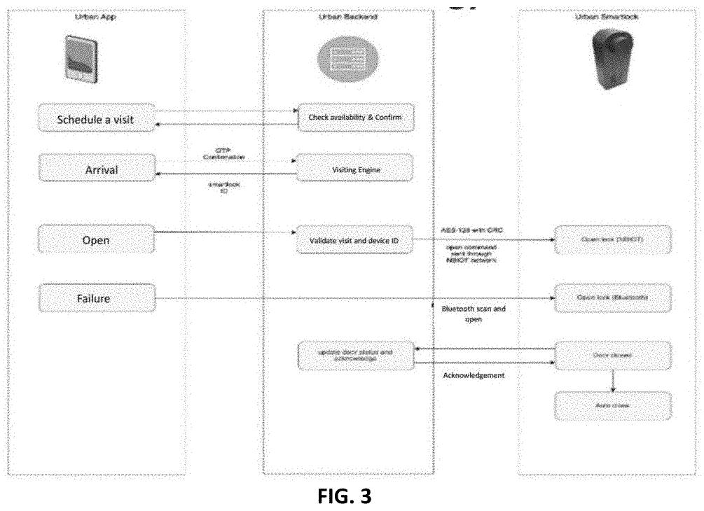

FIG. 3 shows a self-visitation enablement through implementing a hybrid smart lock solution based on narrow band IoT technology optimized for power consumption, and data usage running on client-server UDP architecture, with a fallback mechanism based on direct Bluetooth connectivity.

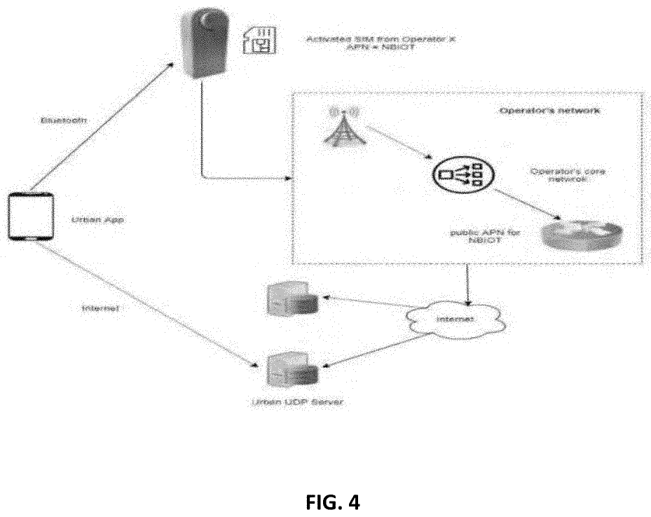

FIG. 4 shows how smart lock devices connect to the operator APN network

Being first in market Urban platform enables users to visit properties without assistance of realtor with a fully self-led visitation feature powered by smart lock & NB-IoT technology. FIG. 19 shows the graphical user interface of the URBAN platform when used for self-led visitation of properties

Real Time Rental Bidding Engine

The platform allows users (prospect tenants) to place offers on property triggering a real time auction window. All properties on auction will be featured in special carousel in explore screen bringing more attention to these properties.

Users can update or cancel their offers within the timed window. Once the window closes all offers will be automatically evaluated to ensure best ROI for landlord.

By way of a non-limiting example, the user may use the platform to perform the following tasks:

Making an offer: a movable slider allowing user to change price and offer a desired price, calendar selection for moving date required for evaluating overall offer value, a final confirmation window before submitting an offer, awful confirmation window with details about the submitted offer

Live auction: automatically created auction carousel featuring all properties on live auction; property with live auction window showing a real time status end window timer; a live placed offer with offer details and date of submission; ability to change offer within the live auction window

Auction ended: A rejected offer; an accepted offer with the timer for offer validity.

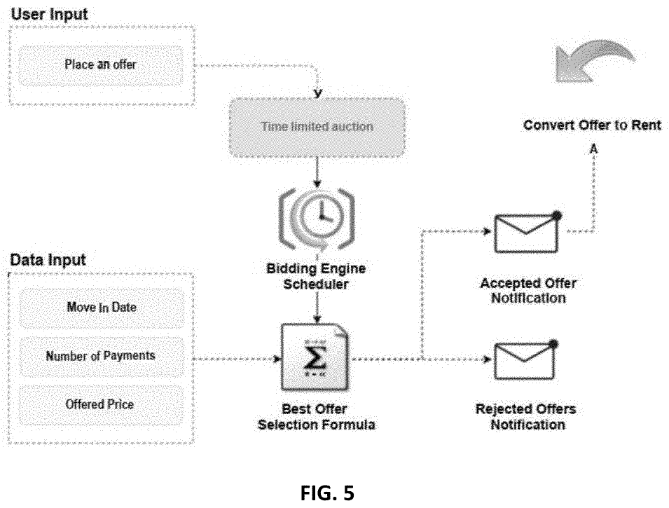

FIG. 5 Shows a real time rental bidding engine technology based on Spring™ and Java™. Our building engine will use the first renting offer to kick off timed scheduler to select the winning offer based on multi-factor selection formula. the bidding engine scheduler overrides the predefined price giving the user option to convert their winning offer to a rent.

The platform allows users (prospect tenants) to place offers on property triggering a real-time auction window. All properties on auction will be featured in special carousel in explore screen bringing more attention to these properties.

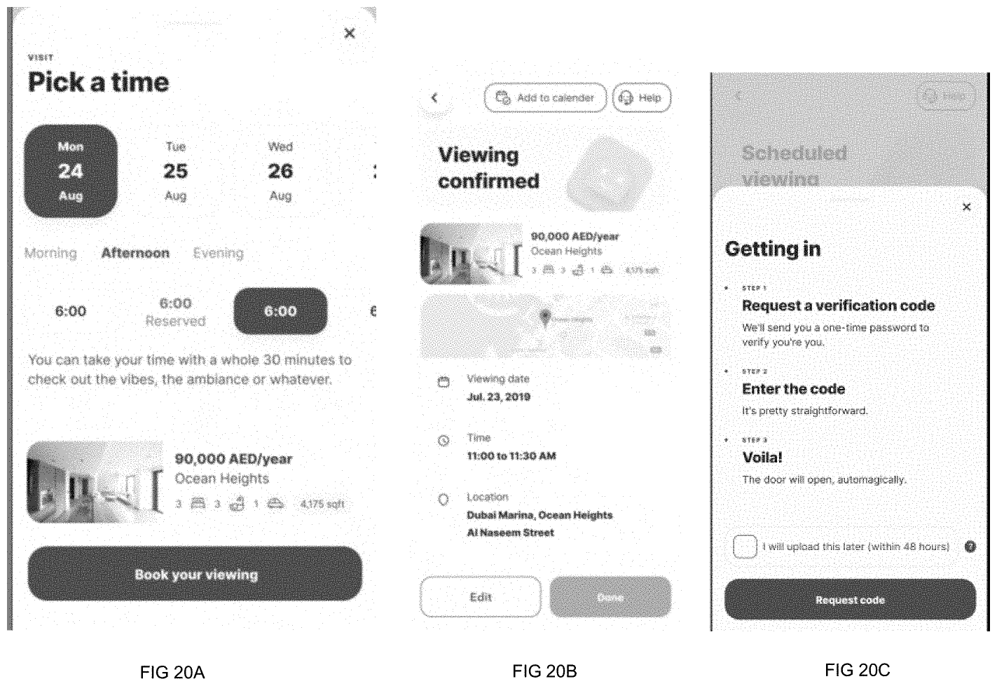

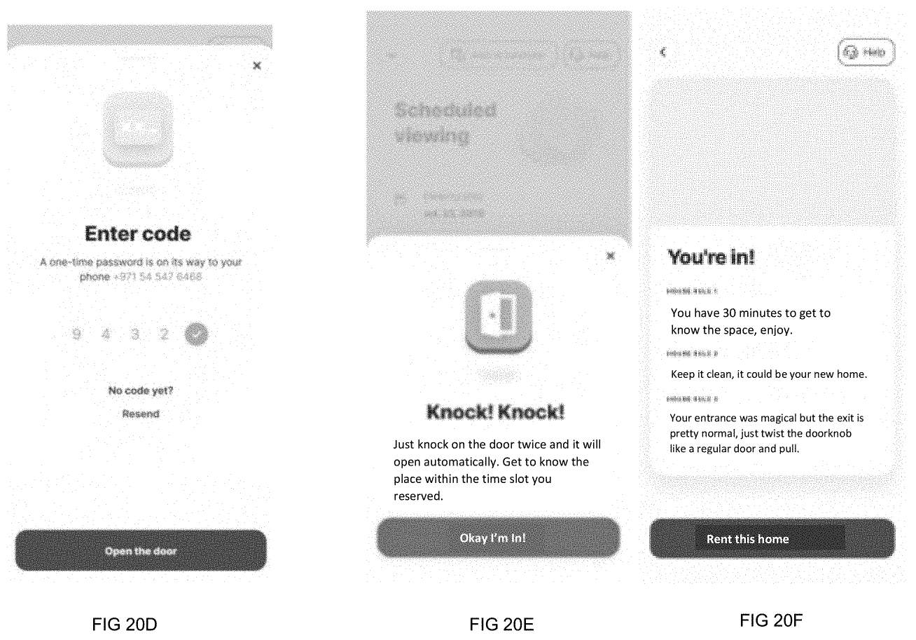

Users can update or cancel their offers within the timed window. Once the window closes all offers will be automatically evaluated to ensure best ROI for landlord. FIG. 20 shows the graphical user interface of the URBAN platform when used for bidding of properties

Fully Digital Long Term Rental Journey

Through Urban, users can complete the digital renting journey from booking the property to moving-in with multiple payment plans, different payment options, digital contract signing & real-time tenancy application tracking.

By way of a non-limiting example: Users can switch between payment plans. payment plans availability are configurable based on landlords requirements; calendar view for moving in date selection; a price breakdown to all charges an ability to choose between different payment options; uploading user tenancy documents, user have the chance to upload before reservation or later; online payment of reservation fees through online payment gateway; booking card in user dashboard showing status of current tenancy application and upload documents in case they haven't uploaded it; users can track their application status in real time the deadlines for each step in the journey.

Fully Customizable Renting Engine on Top of a Dynamic Workflow Framework

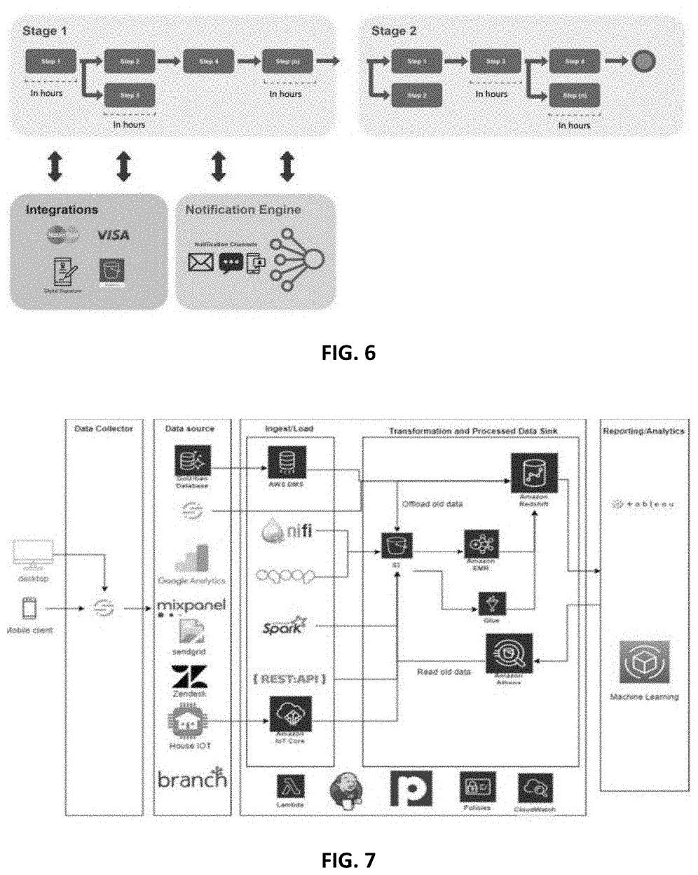

The booking journey is built as a flow of stages. Each stage is built of multiple steps that can be executed sequentially or in parallel. Each step will have input and output that will trigger the start of the next step. Some steps might have time window and will be expired if no action is taken within that window and will cause the whole booking to be cancelled. Once all the steps in a stage are completed, it will automatically start the next stage. The workflow is built in a customizable and adaptable way where we can easily add and remove steps and stages and modify the whole flow. FIG. 6 shows a schematic view of the Fully digital long-term renting journey technology.

Homeowners Dashboard

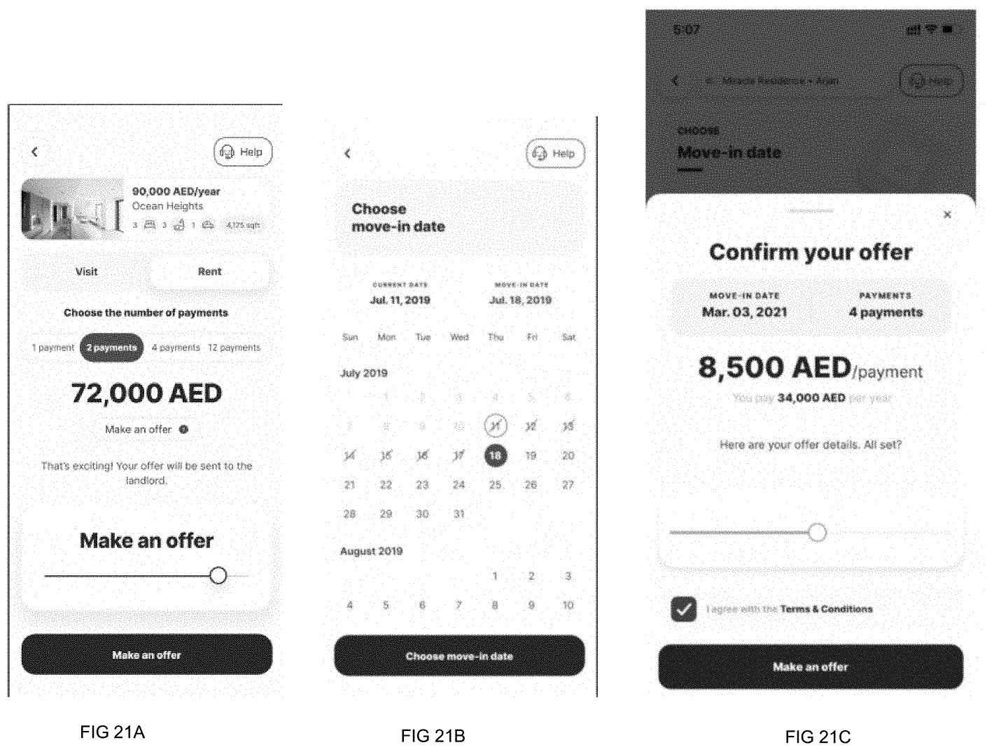

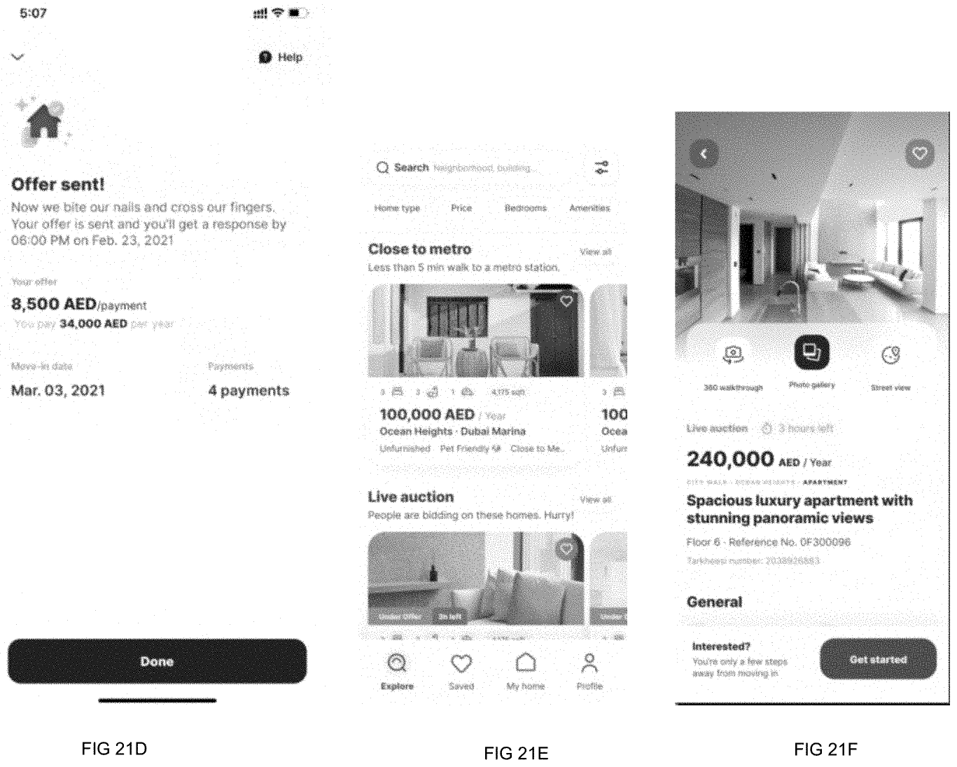

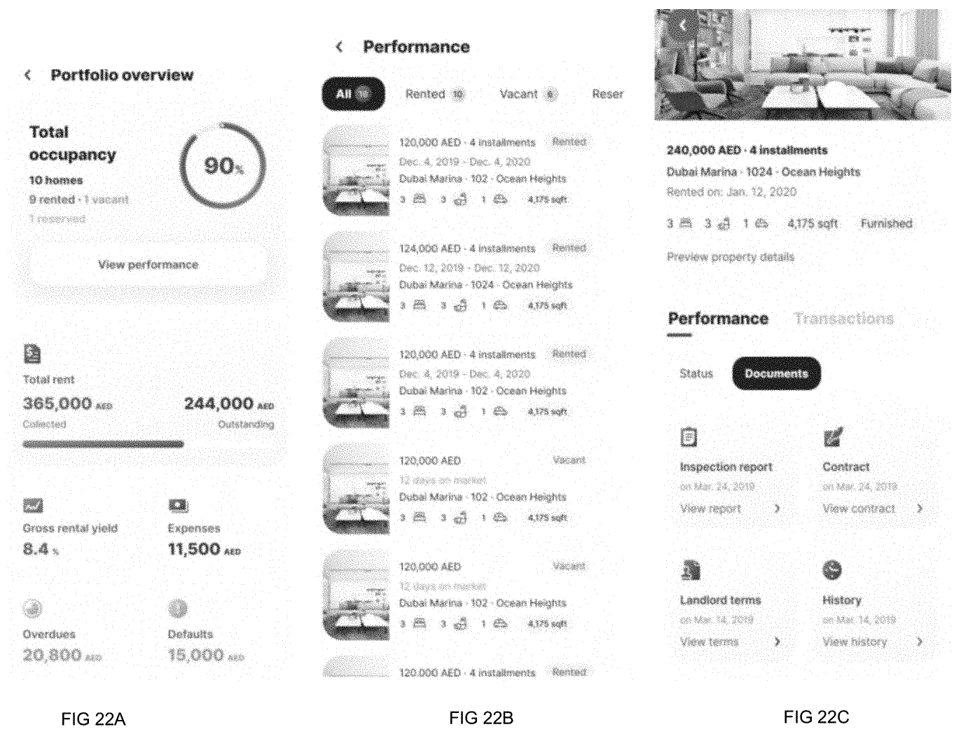

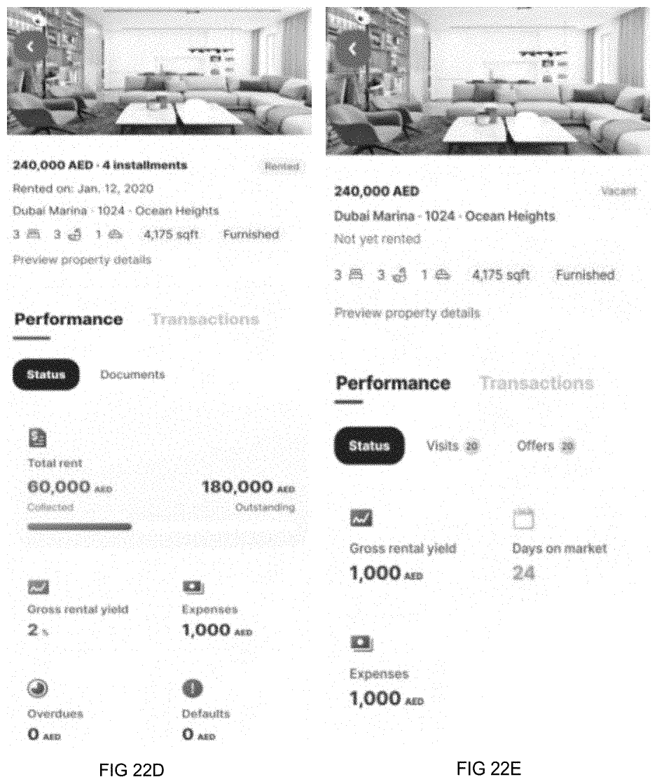

Urban empowers homeowners by providing them with an interface to monitor & track the performance of their listed properties. FIG. 21 shows the graphical user interface of the URBAN platform when used for listing properties

Some Core features include: Multiple payment options; Robust payment management services; Secured Cloud Native services; Multiple notification channels; Digital signature and document management

Technology Stack

Table 1 and Table 2 include a list of all languages, frameworks and services used to build the Urban system and infrastructure.

TABLE 1

| Technology | Architecture Tier | Scalable |
|---|---|---|
| EKS | Orchestration | Yes |
| Docker | Containerization | Yes |
| ECR | Repository | No |
| Spring Cloud Gateway | API Gateway | Yes |
| Eureka | Service Discovery | Master-slave |
| Redis | Internal caching | Yes |
| RabbitMQ | Internal queuing | Yes |
| Aurora - Mysql | Database | Yes |
| S3 Bucket | Asset Storage | Yes |
| Nginx | Web proxy | Yes |
| Cloud front | Content Delivery Network | Yes |
| OpenJDK 8 | Application | N/A |

TABLE 2

| Technology | Architecture Tier | Scalable |
|---|---|---|
| Spring 5 Framework stack | Application | Yes |
| Spring Boot 2 | Application | Yes |
| EC2 | Computing | No |
| Apache Gradle | Application | N/A |
| RedShift | Database | Yes |
| Jetty and Netty Webservers | Application | Yes |
| Jenkins | CI/CD | Yes |
| Appium | Automation | Yes |
| Selenium | Automation | Yes |
| Rest Assured | Automation | Yes |
| Locust | Automation | Yes |

Data Warehouse Architecture

FIG. 7 shows how collecting and managing data from different data sources in one centralized storage is used for analysis and business intelligence.

Smart Lock APN Network

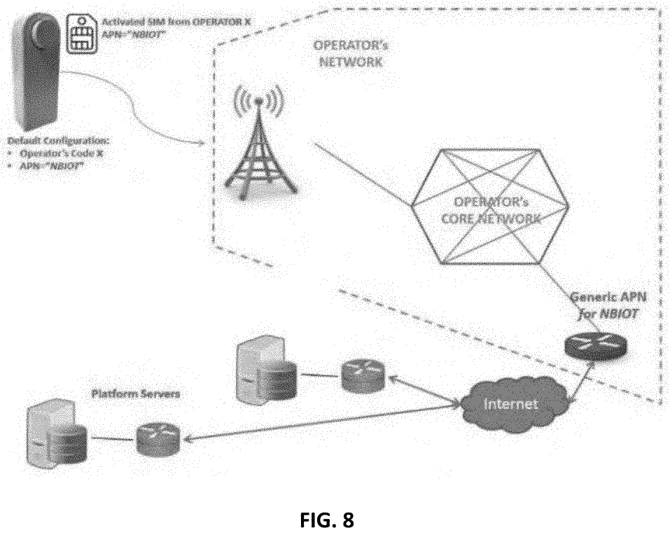

FIG. 8 shows how smartlock devices connect to the operator APN network

Network Architecture

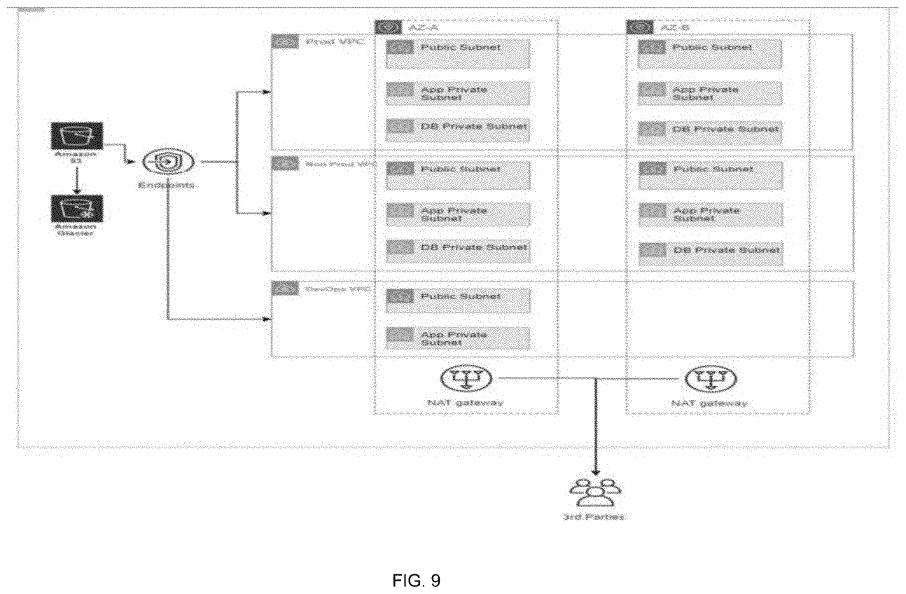

FIG. 9 shows Logical grouping of the infrastructure environments on network level showing how we secure and manage internal and external access

CI-CD Architecture

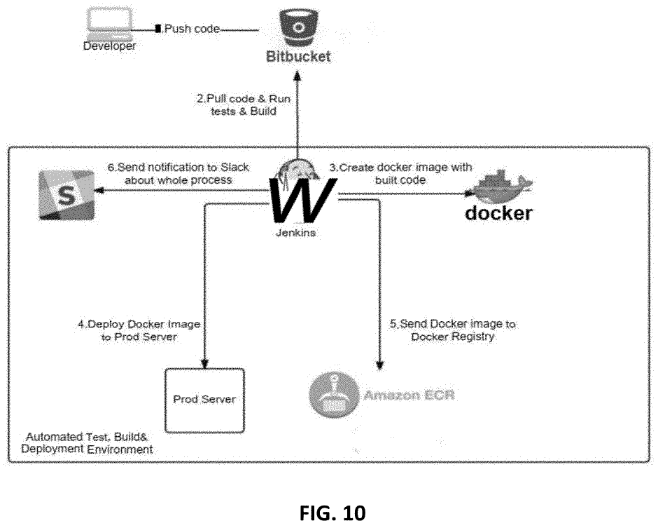

FIG. 10 shows an overview of the automated process to build and release the application artifacts through predefined pipelines

Smartlocks

Different smartlocks known in the field maybe used to implement the current invention. by way of a non-limiting example—the ILK3000™ smartlock by AMPER may be used.

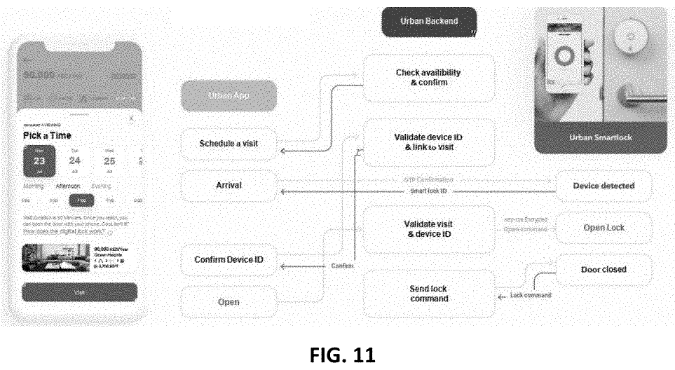

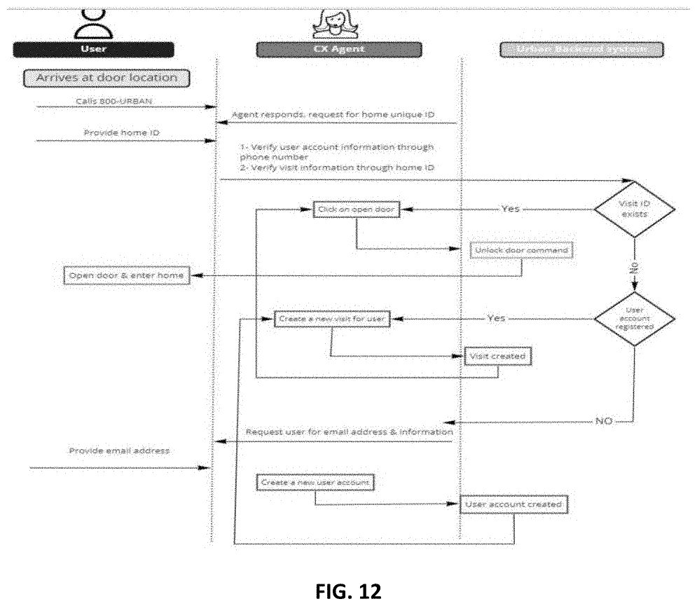

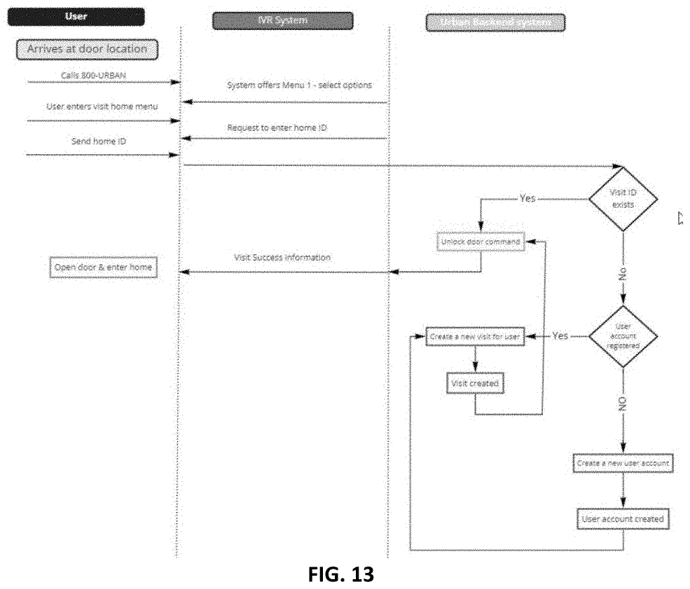

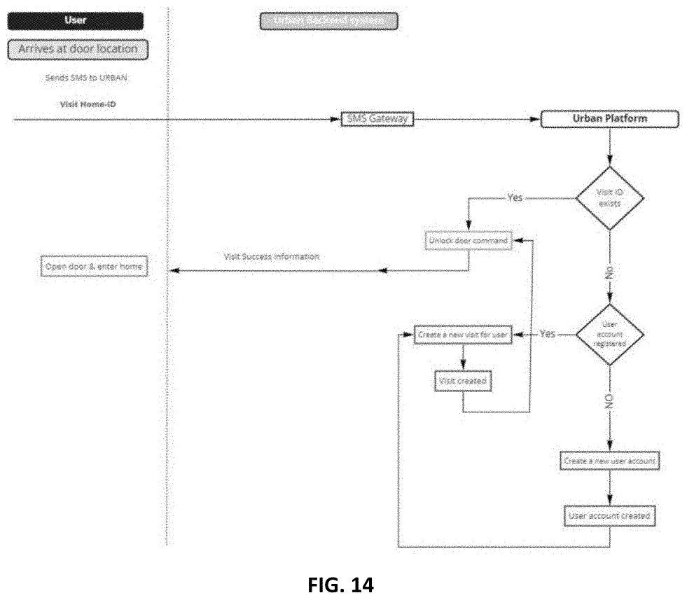

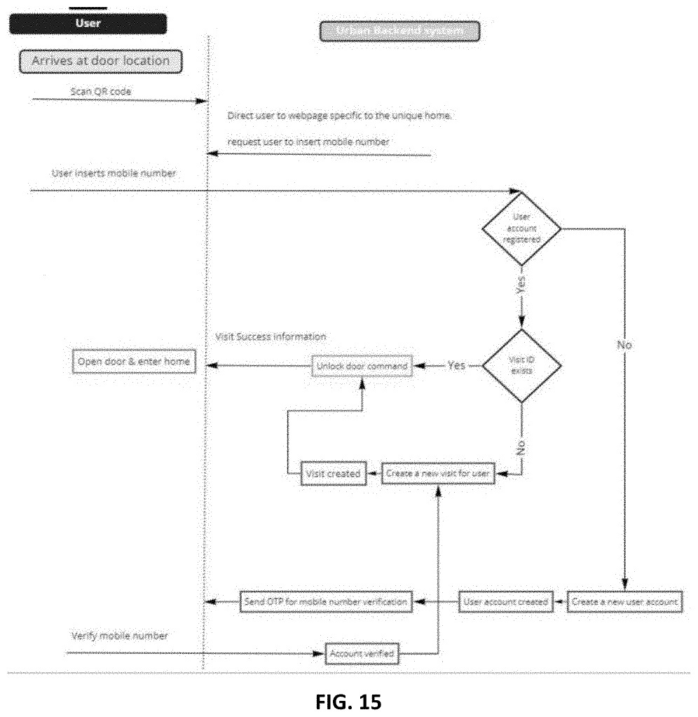

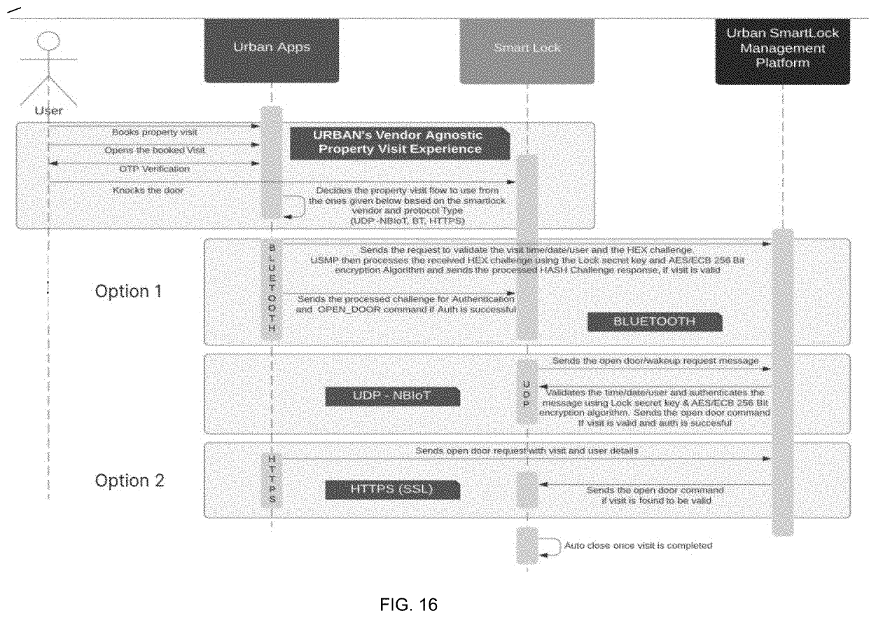

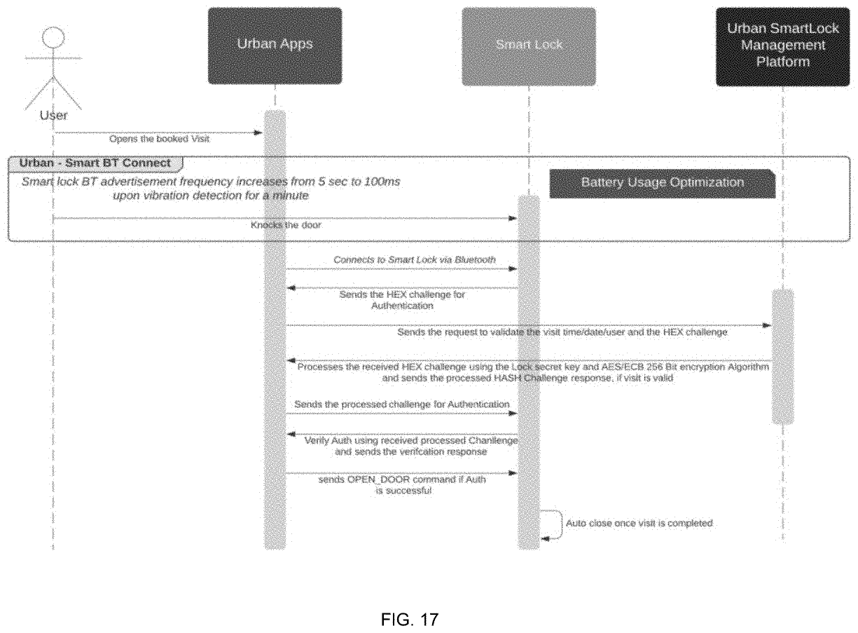

FIG. 11 shows a schematic view of the property visiting journey. Another aspect of the invention relates to the Urban simple visiting experience:
1. Urban simple visiting experience
Urban users can enjoy a simple visit experience to any urban home with a smart lock. Each home has a specific unique ID that will be available to users on the door. This experience allows all user quick accessibility to home even if not a registered Urban user. Once user arrives to the door location, they can access the property by utilizing any of the 4 methods.
   1.1 Human assisted call
   With Urban simple visiting experience, users will be able to open any urban home door with a simple human assisted call. FIG. 12 shows a flow chart describing a protocol used by the URBAN system to verify the identity of the user and allow access to the property.
   1.2 IVR call
   With Urban simple visiting experience, users will be able to open any urban home door by simple IVR assisted call. FIG. 13 shows a flow chart describing another protocol used by the URBAN system to verify the identity of the user and allow access to the property according to the current embodiment.
   1.3 SMS
   With Urban simple visiting experience, users will be able to open any urban home door with a text message. With each home having a unique ID user can send SMS to an Urban dedicated number with a special format. FIG. 14 shows a flow chart describing a protocol used by the URBAN system to verify the identity of the user and allow access to the property according the current embodiment.
   1.4 QR reader
   With Urban simple visiting experience, users will be able to open any urban home door with a QR code scanner. FIG. 15 shows a flow chart describing a protocol used by the URBAN system to verify the identity of the user and allow access to the property according to the current embodiment.
2. Vendor agnostic smartlock management platform
For self-visitation enablement, Urban smartlock management platform (USMP) supports any lock type based on their communication protocols: UDP (NB-IoT), Bluetooth, and HTTPS/SSL (over3G/4G technologies). Any smartlock vendor supporting these communication channels and protocols can be seamlessly integrated with USMP's existing smartlock solution framework.
Moreover, USMP provides a Vendor Agnostic property visiting experience irrespective of the vendor, communication protocol, or the lock type installed at the property.
USMP also enables our operations and field teams to assign, configure, or change the lock type for a property during or even after the lock installation. FIG. 16 shows a flow chart describing another protocol used by the URBAN system to verify the identity of the user and allow access to the property.
3. Smart Bluetooth connectivity
Urban has developed an advanced and smart technology in collaboration with Amper called Urban Smart BT Connect™ that utilizes the smart-lock's vibration/motion detection technology to solve the universally-known problem of Bluetooth's heavy battery usage. The technology increases the smartlock Bluetooth advertisement frequency from 5 secs to 100 milliseconds for a minute only upon detecting a vibration (door knock) for facilitating the smooth Bluetooth connection. For the rest of the time, the BT advertisement frequency stays at 5 secs reducing the overall battery consumption considerably, thus optimizing the battery usage as well as the battery life. FIG. 17 shows a flow chart describing the operation of the Smart BT technology.

Benefits of the Invention
Rent out your property faster: Matterport® 360 virtual tours; Viewings via digital locks; Inspected & utilities connected
Maximize your returns: Data driven rent pricing; Closed auctions; Property analytics
Find & keep the right tenants: Comprehensive credit checks; World class support team; Maintenance you can rely on
Your property in its best light: Beautiful photography and Matterport® virtual tours that make your place impossible to miss.
Viewings, any time: Increase viewings via secure digital locks so prospective renters can visit whenever they want.
Move in ready experience: Inspected, cleaned, and with water and power running for a viewing experience like no other.
Informed pricing to increase returns: Data-driven insights that prices your property for the highest returns while lowering risk.
Closed auctions to capture demand: We'll set up auctions so renters can make offers to outbid others-maximizing property value.
Property analytics: Powerful reporting and market data to make sure you've got an edge over the rest of the market.
Vet and empower tenants at no risk to you: Receive fixed payments from us while we offer payment options to credit checked tenants.
Dedicated asset manager at your service: A single point of contact equipped with powerful tools to monitor and manage your property.
Maintenance calls, we answer: Professional support to boost your tenant experience and keep you worry-free.

1. A method for optimizing real estate renting including one or more features as described and defined in the accompanying description and/or drawings.

2. A system for optimizing real estate renting including one or more features as described and defined in the accompanying description and/or drawings.
